(19) United States
(12) Patent Application Publication
(10) Pub. No.: US 2007/0138018 A1
(43) Pub. Date: Jun. 21, 2007

(54) Image drum and method for manufacturing the image drum

(75) Inventors: Won Kyoung Choi, Suwon-si (KR); Kyu Ho Shin, Seoul (KR); Kae Dong Back, Yongin-si (KR); Soon Cheol Kweon, Seoul (KR); Chang Seung Lee, Yongin-si (KR); Ki Deok Bae, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/487,448

(22) Filed: Jul. 17, 2006

(30) Foreign Application Priority Data
Dec. 15, 2005 (KR) 10-2005-0123852

(51) Int. Cl. B41C 3/08; B32B 37/00

(52) U.S. Cl. 205/127; 205/921; 156/280

(57) ABSTRACT

An image drum for selectively adsorbing a toner thereon so as to form an image in a printing apparatus. The image drum provides a new manufacturing method which can connect ring electrodes formed on the circumferential surface of a drum body and a printed circuit board including a control chip for supplying a necessary voltage to each ring electrode without using a laser processing. Namely, various manufacturing methods, such as a method of forming a connection hole by initially forming a bead made of a hydrophobic material or a conductive bump and removing the initially formed bead or conductive bump, and forming a ring electrode by filling a conductive material in the connection hole, and the structure thereof are provided. Accordingly, due to a simplified manufacturing process, manufacturing cost are reduced and an image drum may be more widely disseminated.

### CROSS-REFERENCE TO RELATED APPLICATION

This application claims priority from Korean Patent Application No. 10-2005-123852, filed on Dec. 15, 2005, in the Korean Intellectual Property Office, the disclosure of which is incorporated herein by reference.

### BACKGROUND OF THE INVENTION

1. Field of the Invention

The present invention relates to an image drum utilized for a printing apparatus. More particularly, the present invention relates to an image drum which can improve productivity and reduce manufacturing cost by simplifying a connection method between ring electrodes formed on a circumferential surface of a drum body and a printed circuit board provided with a control chip applying voltage to the ring electrodes.

2. Description of Related Art

FIG. 1 is a perspective view illustrating a conventional image-forming element according to conventional art, and FIG. 2 is a partially enlarged cross-sectional view illustrating a portion of the circumferential wall of the image-forming element according to the conventional art. The image-forming element shown in FIGS. 1 and 2 is disclosed in U.S. Pat. No. 6,014,157 by reference.

Referring to FIGS. 1 and 2, a conventional image-forming element 10 includes a hollow cylindrical drums body 12 which is made of metal, preferably aluminum or an aluminum alloy. A plurality of circumferentially extending electrodes 14 are formed on the outer circumferential surface of the drum body 12. These electrodes 14 are electrically insulated from one another and from the drum body 12 and are covered by a thin layer of insulating layer. The electrodes 14 may generally be designed depending on the desired resolution of the images to be formed, but are preferably provided densely over the whole length of the drum body 12 to be arranged with a pitch of, for example, about 40 μm in order to realize a resolution of approximately 600 dots per inch (dpi).

An elongate-shaped control unit 16 is mounted inside of the hollow drum body 12 such that a terminal array 18 formed at a longitudinal edge of the control unit 16 adjoins the internal wall of the drum body 12. The control unit 16 is arranged for individually applying a suitably high voltage to each of the electrodes 14 via the terminal array 18 in accordance with the image formation. As shown in FIG. 2, the individual electrodes 14 are formed as grooves separated by adjacent insulating ridges 20 and are filled internally with electrically conductive material 32. Since the electrically conductive material 32 fills in a small diameter hole 24 and a large diameter hole 26 constituting a through-hole 22, the electrodes 14 are electrically connected to zebra-strips 36 disposed at the inner wall surface of the drum body 12 via the through-hole 22. In this case, an anodized surface layer 34 is present at the outer circumferential surface of the drum body 12 and at the internal wall of the through-holes so as to electrically insulate the drum body 12 and the electrodes 14 from each other.

In order to manufacture the image-forming element 10, the cylindrical drum body 12 is provided. The grooves are cut into the outer circumferential surface of the drum body 12, for example, by means of a diamond chisel to have a pitch of approximately 40 μm and a width of approximately 20 μm to form the electrodes 14. Alternatively, these grooves may be formed on the outer circumferential surface of the drum body 12 by using a laser beam or an electron beam.

In the next step, the large diameter holes 26 are cut into the wall of the drum body 12 from inside by, for example, a laser beam. The small diameter holes 24 may also be formed with a laser beam, either from the inside or outside of the drum body 12 to thereby form the through-holes 22. After the through-holes 22 including the small diameter holes 24 and the large diameter holes 26 have been formed, the whole drum body 12 is anodized so as to form the insulating metal oxide layer 34 on the whole surface of the drum body 12. Thereafter, the electrically conductive material 32 fills in the grooves and the through-holes 22. The outer or inner circumferential surface of the drum body 12 is cut to a predetermined depth through polishing so as to effectuate the electrodes 14 and electrical connection portions inside of the through-holes 22. An insulating layer is formed on the outer circumferential surface of the drum body 12 and the control unit 16 is disposed inside of the drum body 12 so as to complete the manufacture of the image-forming element 10.

As described above, in order to form the electrodes 14 on the outer circumferential surface of the drum body 12, the grooves are densely formed over the whole length of the drum body 12 using a precise cutting tool and the through-holes 22 must be formed at regular intervals either from the inside or outside of the drum body 12. After the formation of the anodized surface layer on the outer circumferential surface of the drum body 12 and at the internal wall of the through-holes 22, the electrically conductive material 32 is filled into the grooves and the through-holes 22 and is removed until a desired thickness remains. Specifically, it takes very long to make the through-holes 22 for connecting the electrodes 14 and the control units 16 and to fill the electrically conductive material 32 in the through-holes 22. Also, the manufacturing cost is significantly high and defects regularly occur. Accordingly, a new image drum and a method of manufacturing the image drum are needed, which can improve productivity and reduce manufacturing cost.

### SUMMARY OF THE INVENTION

The present invention provides an image drum which can be easily fabricated and has excellent printing quality, and a method of manufacturing the image drum.

The present invention also provides an image drum which can be readily and easily fabricated, is advantageous for mass production, and can reduce manufacturing cost, and a method of manufacturing the image drum.

The present invention also provides an image drum which reduces manufacturing and product costs since fine processing using a laser is not necessary for forming a connecting part which connects each ring electrode to a terminal of a control chip.

According to an aspect of the present invention, there is provided a method of manufacturing an image drum for selectively adsorbing toner thereon so as to form an image, the method including: providing a hollow cylindrical drum body having a printed circuit board provided inside of the drum body and exposing a terminal array; forming a temporary (removable) structure on each terminal in the array; coating an insulating layer on an area excluding the temporary structure; forming a connection hole by selectively removing the temporary structure; filling a conductive material in the connection hole; and forming a plurality of ring electrodes which are circumferentially arranged in parallel with a circumferential surface of the drum body to pass through the conductive material.

In this instance, the filling of the conductive material may apply a conductive material over the connection hole, selectively polish the conductive material and remove the same to leave the conductive material in the connection hole. Also, the coating of the insulating layer includes: coating the insulating layer on the exposed surface of the printed circuit board including the temporary structure; and externally exposing the temporary structure by polishing the insulating layer. The temporary structure may be a fixing device which is fixed on the terminal array with a certain height.

The providing of the printed circuit board further includes overlapping a plurality of sheets of printed circuit boards, where each terminal on the respective sheets of the printed circuit board has a constant pitch. Also, the providing of the printed circuit board may further include processing the exposed surface of the drum body and the printed circuit board by lathing after the bonding. The forming of the plurality of ring electrodes may further include coating an insulating layer on the plurality of ring electrodes.

The providing of the drum body further includes forming a hollow in the drum body, and having a mounting hole pass through the hollow to provide the printed circuit board in the hollow.

According to another aspect of the present invention, there is provided a method of manufacturing an image drum for selectively adsorbing a toner thereon so as to form an image, the method including: providing a hollow cylindrical drum body, providing a printed circuit board provided inside of the drum body and exposing a terminal array; dotting a bead formed of a hydrophobic material on the terminal array; coating an insulating layer on the exposed surface of the printed circuit board excluding the bead; forming a connection hole by selectively removing the bead; filling a conductive material in the connection hole; and forming a plurality of ring electrodes which are circumferentially arranged in parallel with a circumferential surface of the drum body to pass through the conductive material.

The coating of the insulating layer includes coating the insulating layer on the exposed surface of the printed circuit board including the bead and externally exposing the bead by removing the insulating layer. Also, the bead of a hydrophobic material is formed of any one of a polydimethylsiloxane, a hydrophobic oil, and a hydrophobic wax, or a mixture thereof.

According to still another aspect of the present invention, there is provided a method of manufacturing an image drum for selectively adsorbing a toner thereon so as to form an image, the method including: providing a cylindrical drum body including a mounting hole in a longitudinal direction; bonding a printed circuit board, including a control chip for applying voltage to ring electrodes, to the mounting hole to externally expose a plurality of terminals contacting the control chip; forming a conductive bump to have a predetermined height on the terminal; coating the exposed surface of the printed circuit board excluding the conductive bump, to form an insulating layer; and forming a plurality of ring electrodes which are circumferentially arranged in parallel with a circumferential surface of the drum body and the printed circuit board, to pass through the conductive bump.

According to yet another aspect of the present invention, there is provided a method of manufacturing an image drum for selectively adsorbing a toner thereon so as to form an image, the method including: providing a cylindrical drum body including a mounting hole in a longitudinal direction; bonding a printed circuit board, including a control chip for applying voltage, to the mounting hole to Externally expose a terminal contacting with the control chip, with the printed circuit board being protruded from a circumferential surface of the image drum; partially removing the portions of the protruded printed circuit board, to allow only a portion of the terminal to protrude; coating an insulating layer on the exposed surface of the printed circuit board excluding the protruded terminal; and forming a plurality of ring electrodes, which are circumferentially arranged in parallel with a circumferential surface of the drum body and the printed circuit board, to pass through the protruded terminal.

According to a further aspect of the present invention, there is provided a method of manufacturing an image drum for selectively adsorbing a toner thereon so as to form an image, the method including: providing a cylindrical drum body including a mounting hole in a longitudinal direction; bonding a printed circuit board, including a control chip for applying voltage, to the mounting hole to externally expose a terminal contacting the control chip; coating the externally exposed printed circuit board to form an insulating layer; forming a connection hole in the insulating layer by piercing the insulating layer with a piercing tool having a sharp end, so as to externally expose the terminal; filling a conductive material in the connection hole; forming a plurality of ring electrodes, which are circumferentially arranged in parallel with the exposed surface of the drum body and the printed circuit board, to pass through the conductive material.

According to another aspect of the present invention, there is provided a method of manufacturing an image drum for selectively adsorbing a toner thereon so as to form an image in a printing apparatus, the method including: providing a cylindrical drum body including a mounting hole in a longitudinal direction; bonding a printed circuit board, including a control chip for applying voltage, to the mounting hole to externally expose a plurality of terminals contacting the control chip; fixing a fixing device on the terminal; coating the exposed surface of the printed circuit board so as to form an insulating layer; forming a connection hole in the insulating layer where the fixing device is positioned, by separating the fixing device; filling a conductive material in the connection hole; and forming a plurality of ring electrodes, which are circumferentially arranged in parallel with the exposed surface of the drum body and the printed circuit board, to pass through the conductive material.

According to an aspect of the present invention, there is provided an image drum for selectively adsorbing a toner thereon so as to form an image, the image drum including: a cylindrical drum body including a mounting hole in a longitudinal direction, and a plurality of ring electrodes which are arranged in parallel with each other on its circumferential surface and electrically insulated from each other; a printed circuit board, including a control chip for applying voltage to the ring electrodes respectively, bonded to the mounting hole to externally expose a plurality of terminals contacting the control chip; and a connecting part which connects each terminal and ring electrode respectively by filling an insulating layer in the connection hole, where the connection hole is in a sphere shape or in a portion thereof and formed on the terminal radially.

According to another aspect of the present invention, there is provided an image drum for selectively adsorbing a toner thereon so as to form an image, the image drum including: a cylindrical drum body including a mounting hole in a longitudinal direction, and a plurality of ring electrodes which are arranged in parallel with each other on its circumferential surface and electrically insulated from each other; a printed circuit board, including a control chip for respectively applying voltage to the ring electrodes, bonded to the mounting hole to externally expose a plurality of terminals contacting the control chip; and a connecting part which connects each ring electrode of the plurality of ring electrodes, and conductive bump, which is initially formed on the terminal, with a subsequently formed insulating layer surrounding the conductive bump.

According to an aspect of the present invention, there is provided an image drum for selectively adsorbing a toner thereon so as to form an image, the image drum including: a cylindrical drum body including a mounting hole in a longitudinal direction and a plurality of ring electrodes which are arranged in parallel with each other on its circumferential surface and electrically insulated from each other; a printed circuit board, including a control chip for respectively applying voltage to the ring electrodes, bonded to the mounting hole to externally expose a plurality of terminals contacting with the control chip; and a connecting part which connects each terminal and ring electrode respectively by filling an insulating layer in the connection hole, where the connection hole is in a shape of a pyramid or a cone and formed on the terminal radially.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a perspective view illustrating a conventional image-forming element according to conventional art;

FIG. 2 is a partially enlarged cross-sectional view illustrating a portion of the circumference wall of the conventional image-forming element according to the conventional art;

FIG. 3 is a schematic cross-sectional view illustrating the inner construction of a printer using an image drum according to an exemplary embodiment of the present invention;

FIG. 4 is a partially enlarged perspective view illustrating the image drum shown in FIG. 3;

FIGS. 5 to 13 are views illustrating a manufacturing method according to a first exemplary embodiment of the present invention;

FIG. 5 is a partially enlarged perspective view illustrating a drum body;

FIG. 6 is a partially enlarged perspective view illustrating a printed circuit board bonded to the drum body shown in FIG. 5;

FIG. 7 is a partially enlarged cross-sectional view illustrating a bead dotted on a terminal;

FIG. 8 is a partially enlarged cross-sectional view illustrating a coated insulating layer over the bead shown in FIG. 7;

FIG. 9 is a partially enlarged cross-sectional view illustrating a connection hole formed by removing the bead shown in FIG. 8;

FIG. 10 is a partially enlarged cross-sectional view illustrating an electrically conductive material filled into the connection hole shown in FIG. 9;

FIG. 11 is a partially enlarged cross-sectional view illustrating a portion of electrically conductive material removed through polishing;

FIG. 12 is a partially enlarged cross-sectional view illustrating a formed ring electrode;

FIG. 13 is a partially enlarged cross-sectional view illustrating a coated insulating layer;

FIGS. 14 to 18 are views illustrating a manufacturing method according to a second exemplary embodiment of the present invention;

FIG. 14 is a partially enlarged cross-sectional view illustrating a terminal formed on a conductive bump;

FIG. 15 is a partially enlarged cross-sectional view illustrating an insulating layer coated on the conductive bump shown in FIG. 14;

FIG. 16 is a partially enlarged cross-sectional view illustrating an appearance after grinding the coated insulating layer shown in FIG. 15;

FIG. 17 is a partially enlarged cross-sectional view illustrating a ring electrode formed on the electrically conductive bump shown in FIG. 16;

FIG. 18 is a partially enlarged cross-sectional view illustrating an insulating layer coated on the ring electrode shown in FIG. 17;

FIGS. 19 to 24 are views illustrating a manufacturing method according to a third exemplary embodiment of the present invention;

FIG. 19 is a partially enlarged cross-sectional view illustrating a printed circuit board bonded to a drum body;

FIG. 20 is a partially enlarged cross-sectional view illustrating a partially etched portion of the printed circuit board shown in FIG. 19;

FIG. 21 is a partially enlarged cross-sectional view illustrating an insulating layer coated on an exposed surface of the printed circuit board shown in FIG. 20;

FIG. 22 is a partially enlarged cross-sectional view illustrating an appearance after grinding the coated insulating layer shown in FIG. 21;

FIG. 23 is a partially enlarged cross-sectional view illustrating a formed ring electrode on the grinded exposed surface of the printed circuit board shown in FIG. 22;

FIG. 24 is a partially enlarged cross-sectional view illustrating an insulating layer coated on the ring electrode shown in FIG. 23;

FIGS. 25 to 30 are views illustrating a manufacturing method according to a fourth embodiment of the present invention, wherein:

FIG. 25 is a partially enlarged cross-sectional view illustrating an insulating layer coated on a terminal;

FIG. 26 is a partially enlarged cross-sectional view illustrating a connection hole formed by piercing the insulting layer shown in FIG. 25 using a piercing tool;

FIG. 27 is a partially enlarged cross-sectional view illustrating an electrically conductive material filling in the connection hole shown in FIG. 26;

FIG. 28 is a partially enlarged cross-sectional view illustrating a remaining portion of the electrically conductive material after processing;

FIG. 29 is a partially enlarged cross-sectional view illustrating a formed ring electrode;

FIG. 30 is a partially enlarged cross-sectional view illustrating an insulating layer coated on the ring electrode shown in FIG. 29;

FIGS. 31 to 37 are views illustrating a manufacturing method according to a fifth exemplary embodiment of the present invention;

FIG. 31 is a partially enlarged cross-sectional view illustrating a fixing device fixed on a terminal;

FIG. 32 is a partially enlarged cross-sectional view illustrating an insulating layer formed while the fixing device is fixed on the terminal as shown in FIG. 31;

FIG. 33 is a partially enlarged cross-sectional view illustrating a connection hole formed by removing the fixing device shown in FIG. 32;

FIG. 34 is a partially enlarged cross-sectional view illustrating an electrically conductive material filled into the connection hole shown in FIG. 33;

FIG. 35 is a partially enlarged cross-sectional view illustrating a remaining electrically conductive material filled into the connection hole shown in FIG. 34, after processing;

FIG. 36 is a partially enlarged cross-sectional view illustrating a formed ring electrode; and

FIG. 37 is a partially enlarged cross-sectional view illustrating an insulating layer coated on the ring electrode shown in FIG. 36.

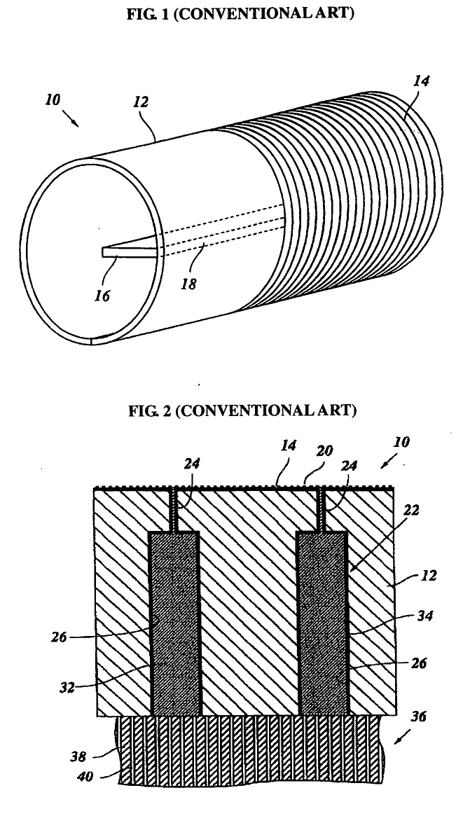

### DETAILED DESCRIPTION OF EXEMPLAR EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

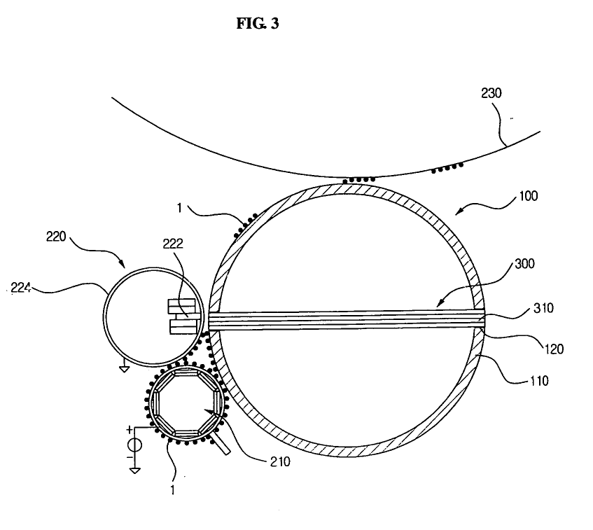

FIG. 3 is a schematic cross-sectional view illustrating the inner construction of a printer using an image drum according to an exemplary embodiment of the present invention.

Referring to FIG. 3, the image drum 100 includes a cylindrical drum body 110 and a printed circuit board 300 bonded to a mounting hole 120 of the drum body 110. A toner feed roller 210, 4 magnetic cutter 220 and an image transfer section 230 are disposed around the outer circumferential surface of the image drum 100. A toner 1 from a toner storage section (not shown) is supplied to the toner feed roller 210. The supplied toner 1 is transferred to the image drum 100 from the toner feed roller 210 while moving on the outer circumferential surface of the toner feed roller 210. In this instance, the toner 1 is kept in an electrically charged state, and is transferred to the magnetic cutter 220 while maintaining a contact with an insulating layer formed on the outermost circumferential portion of the image drum 100.

The magnetic cutter 220 includes a rotary sleeve 224, and a magnet 222 disposed within the magnetic cutter 220 for applying an attraction force to the toner 1. The magnet 222 is positioned adjacent to the image drum 100, and can attract the toner 1 adhered to the surface of the image drum 100 using a magnetic force. The magnet 222 has a sufficient magnetic force which can collect the toner 1 from the electrodes of the image drum 100 which is not applied with a voltage. The toner 1 collected by the magnet 222 is fed back to the toner storage section or the toner feed roller 210 through the rotary sleeve 224.

The toner 1, which is not fed back to the toner storage section or the toner feed roller 210 by the magnetic cutter 220, is transferred to the image transfer section 230 from the outer circumferential surface of the image drum 100. Then, the toner 1 transferred to the image transfer section 230 is moved to a printing paper sheet which is in turn heat-treated so as to allow the toner 1 to be adhered to the surface of the printing paper sheet. The image drum 100 controls the voltage applied to the electrodes to conform to an image signal. Subsequently, the image drum 100 generates an electrostatic force larger than that of the magnet 222 so as to prevent the toner 1 from being collected to the magnetic cutter 220.

Approximately five thousand electrodes are controlled independently so as to represent a two dimensional image on the image drum 100. The image represented on the image drum 100 through the toner 1 can be transferred to the printing paper sheet by using the image transfer section 230 as a relay means. After the toner 1 has been adhered to the surface of the printing paper sheet, the printing paper sheet passes through a heat-treatment apparatus. In this instance, the toner is adsorbed to the surface of the printing paper sheet to complete a corresponding printing.

Hereinafter, a configuration of an image drum and a method of manufacturing the image drum according to an exemplary embodiment of the present invention will be described. FIG. 4 is a partially enlarged perspective view illustrating the image drum shown in FIG. 3.

As shown in FIG. 4, the drum body 110 is formed in a hollow cylindrical shape, and may be formed of a material having excellent heat conductivity and mechanical strength. Mounting holes 120, which are open in a longitudinal direction, are disposed on an outside surface on opposite sides of the cross section of the drum body 110, respectively. The printed circuit board 300 is bonded to the mounting holes 120, to externally expose its side face. The printed circuit board 300 will be described later in detail.

A ring electrode 130 is provided on the circumferential surface of the drum body 110. In this instance, the ring electrode 130 may be circumferentially formed on the circumferential surface of the drum body 110 to have a pitch of approximately 40 μm and a width of approximately 20 μm. The ring electrodes 130 covering the circumference of the drum body 110 are formed to have a width corresponding to the printing width of the printing paper sheet. As an example, assuming the printing paper sheet of A4 size, the drum body 110 is formed to have a length of at least 20 to 22 cm over the whole width thereof. In this instance, each of the ring electrodes 130 may be formed to have a pitch of approximately 40 μm to achieve about five thousand lines. The ring electrodes 130 can be formed in a ring structure which is closed as one piece or partially opened. That is, both ends of each of the ring electrodes 130 may be electrically interconnected to form a closed ring structure, but it is possible to electrically insulate both ends of the each ring electrode 130 according to circumstances. The ring electrode 130 may be made of silver (Ag).

The printed circuit board 300 is provided with an unillustrated control chip which can individually apply a voltage to each of the ring electrodes 130. The printed circuit board 300 is formed by stacking four sheets of the printed circuit boards 310 and includes a terminal array making contact with the ring electrode 130. The terminal array, which may be formed of copper and is formed on a portion in which the printed circuit board 300, is externally exposed on the circumferential surface of the drum body 110. An insulating layer is coated on the exposed surface of the printed circuit board 300, but not illustrated herein.

The ring electrodes 130 must be connected to the control chip so as to thereby control a voltage of each of the ring electrodes 130. The ring electrode 130 must initially make contact with the terminal of the control chip, so as to be connected with the control chip. Connecting positions will be discussed below.

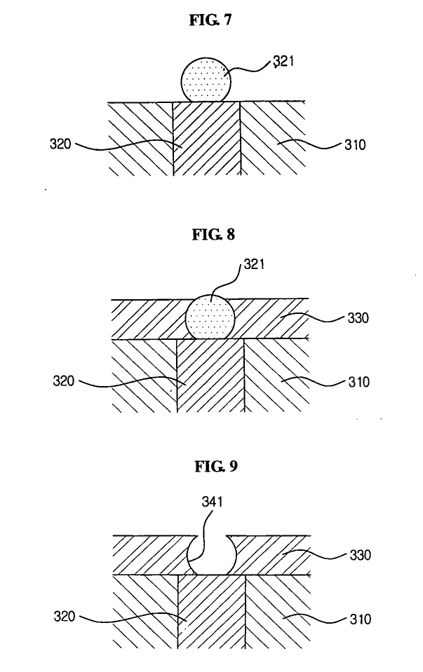

Terminals (shown in FIGS. 7-32) of each sheet of the printed circuit board 310 do not contact with ring electrodes in sequential order. Terminals exposed on one side surface are in contact with, for example, a second, a fourth, and a sixth ring electrode. Namely, from four sheets of printed circuit boards 310, a first sheet of printed circuit board 310 is connected to the second ring electrode and a second sheet of printed circuit board is connected to the sixth ring electrode. Each connection section 131 of each sheet of printed circuit board has a length of about 80 μm, and is arranged with a pitch of about 40 μm. Particularly, a pitch indicates an interval between centers of connection sections 131. A vertical connection section 132 filled with an electrically conductive material is formed on the center of the connection section 130 to connect one terminal of each sheet of printed circuit board 310 with only one ring electrode 130. An insulating layer around the vertical connection portion 132 prevents each ring electrode 130 or each terminal from shorting. Likewise, terminals exposed on one side surface are in contact with, for example, a first, a third, and a fifth ring electrode, which is shown in the circle of FIG. 4.

As described in the conventional art, it takes a very long time to connect each ring electrode 130 and terminal of the control chip in the conventional art. Also, a manufacturing cost is significantly high. However, the present invention suggests a manufacturing method as follows.

Hereinafter, an image drum manufacturing method according to a first exemplary embodiment of the present invention will be described.

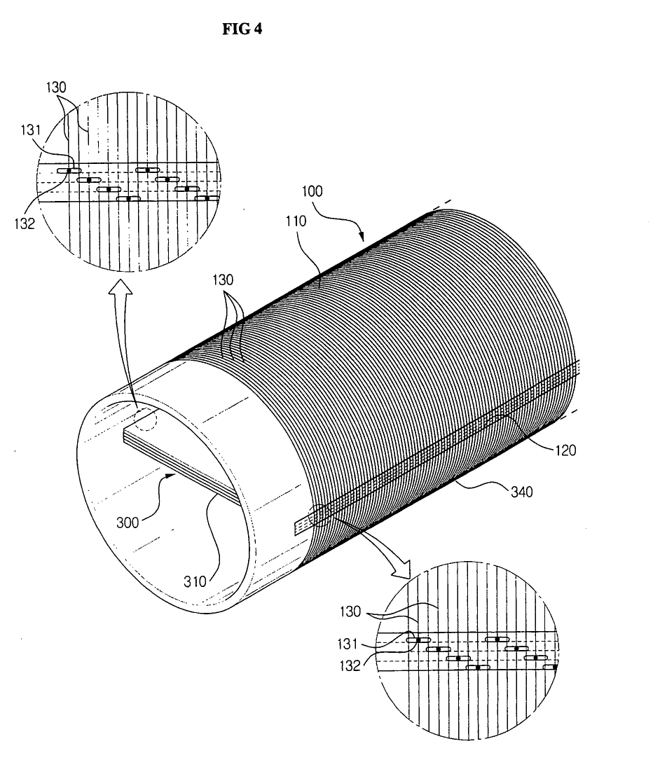

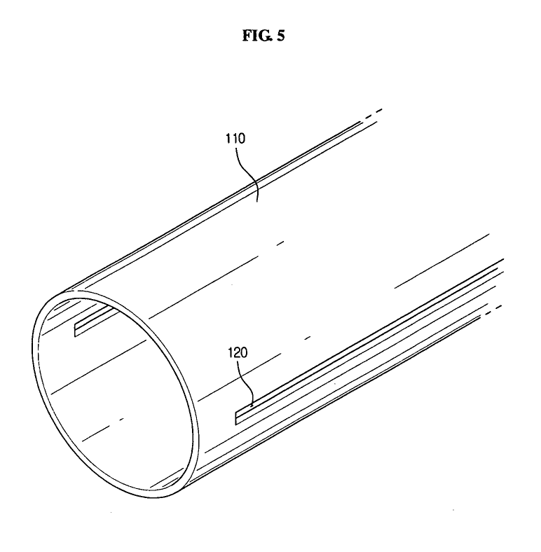

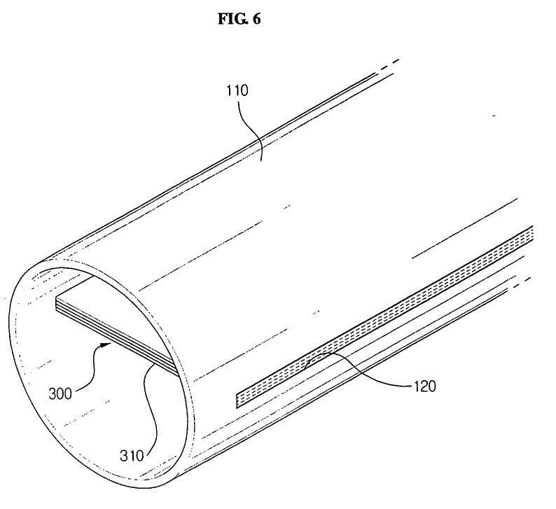

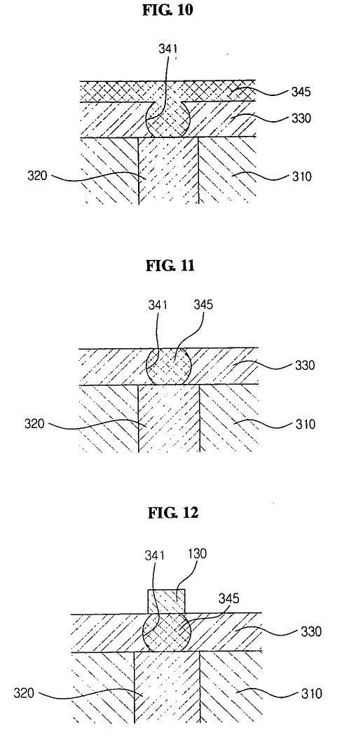

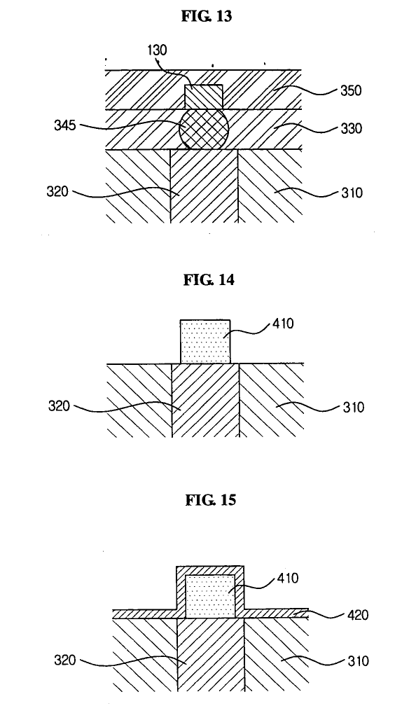

A manufacturing method according to a first exemplary embodiment of the present invention will be described. FIG. 5 is a partially enlarged perspective view illustrating a drum body 110, FIG. 6 is a partially enlarged perspective view illustrating a printed circuit board bonded to the drum body shown in FIG. 5, FIG. 7 is a partially enlarged cross-sectional view illustrating a bead dotted on a terminal, FIG. 8 is a partially enlarged cross-sectional view illustrating a coated insulating layer over the bead shown in FIG. 7, FIG. 9 is a partially enlarged cross-sectional view illustrating a connection hole formed by removing the bead shown in FIG. 8, FIG. 10 is a partially enlarged cross-sectional view illustrating an electrically conductive material filled into the connection hole shown in FIG. 9, FIG. 11 is a partially enlarged cross-sectional view illustrating a portion of electrically conductive material removed through polishing, FIG. 12 is a partially enlarged cross-sectional view illustrating a formed ring electrode, and FIG. 13 is a partially enlarged cross-sectional view illustrating a coated insulating layer.

As shown in FIG. 5, the drum body 110 is formed of a material having excellent heat conductivity and mechanical strength such as aluminum, and is provided through a cutting process. In this instance, the drum body 110 includes mounting holes 120 for mounting a printed circuit board. Two mounting holes 120 are formed on an outside surface on opposite sides of the drum body 110, respectively.

A hollow may be formed in the drum body 110. Also, grooves may be formed on the circumferential surface of the drum body 110 at regular intervals, to have a pitch of approximately 40 μm and a width of approximately 20 μm. The electrodes 130 are disposed on the grooves. The grooves will be described later.

As shown in FIG. 6, the printed circuit board 300 is bonded to the mounting holes 120 of the drum body 110. A control chip for applying a voltage to each of a plurality of ring electrodes is mounted on the printed circuit board 300. Also, the printed circuit board 300 is formed by stacking four sheets of printed circuit boards 310. In this instance, the printed circuit board 300 is bonded to the mounting holes 120 of the drum body 110, to externally expose a plurality of terminals of the control chip. The terminal is formed on each printed circuit board 310. The terminal formed on one sheet of printed circuit board 310 and another terminal formed on another sheet of printed circuit board 310 adjacent to the one sheet of printed circuit board 310 are provided to have a pitch of approximately 40 μm.

The exposed surface of the drum body 110 and the printed circuit board 300 may be processed by lathing.

As shown in FIG. 7, a bead 321 of a hydrophobic material is dotted on a terminal 320 at regular intervals, and the terminal 320 contacts with a control chip. After sufficient time has passed, the dotted bead 321 is hardened from a liquid to a solid and is in the shape of a sphere or a part thereof. Since the bead 321 is dotted on the terminal 320 of a sheet of the printed circuit board 310, each bead 321 is arranged with a pitch of approximately 40 μm. Dotting the bead in the current example is based on a precise process and the description related thereto will be omitted herein for convenience. The bead 321 may be formed of a polydimethylsiloxane, a hydrophobic oil, a hydrophobic wax, and the like.

As shown in FIG. 8, an insulating layer 330 is coated over the exposed surface of the printed circuit board 310 including the terminal 320. Various methods such as chemical vapor deposition (CVD), electrode/non-electrode plating and a thin conductive film using a sputtering method may be utilized as the coating method.

As shown in FIG. 9, a connection hole 341 is formed by removing the bead 321 through lathing. The connection hole 341 may have a similar shape to the removed bead 321. Namely, the connection hole 341 is in the shape of a sphere or a portion thereof.

As shown in FIG. 10, an electrically conductive material 345 coats the exposed surface of the printed circuit board 310 including the connection hole 341. Particularly, the connection hole 341 is filled with the electrically conductive material 345. The electrically conductive material 345 may be formed of Ag.

As shown in FIG. 11, the exposed surface of the printed circuit board 310 formed with the connection hole 341 is processed by lathing or polishing. In this instance, the electrically conductive material 345 remaining is only in the connection hole 341, and the rest is removed through processing.

As shown in FIG. 12, a plurality of ring electrodes 130 are circumferentially arranged in parallel with a circumferential surface of the drum body and the printed circuit board 310, to pass through the electrically conductive material 345 filling in the connection hole 341, through printing. The printing method may utilize a method of initially forming a mask omitting a portion to form the ring electrodes 130 and subsequently applying an electrically conductive material.

When describing modified exemplary embodiments for forming a ring electrode 130, in addition to the methods described in FIGS. 10 and 11, the electrode ring 130 may be formed on the connection hole 341 in one process at the same time when the electrically conductive material 345 fills in the connection hole 341. Alternatively, in FIG. 11, the ring electrode 130 may be formed by selectively removing the electrically conductive material 345 which remains in the connection hole 341.

As shown in FIG. 13, an insulting material 350 is coated on the ring electrode 130. The insulating layer may be formed of parylene.

According to the manufacturing method as described above, the ring electrode 130 is connected to the terminal 320, and the terminal 320 is connected to a control chip (not shown) installed on the printed circuit board 310. Accordingly, the control chip may apply a necessary voltage to each ring electrode 130. Namely, in the present exemplary embodiment, since high cost laser processing is unnecessary, manufacturing cost may be reduced while productivity is improved.

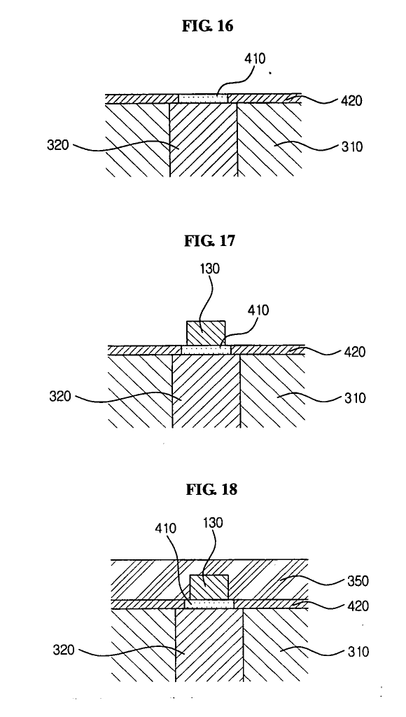

A manufacturing method according to a second exemplary embodiment of the present invention will be described. FIG. 14 is a partially enlarged cross-sectional view illustrating a terminal 320 formed as an electrically conductive bump 410, FIG. 15 is a partially enlarged cross-sectional view illustrating an insulating layer 420 coated on the conductive bump shown in FIG. 14, FIG. 16 is a partially enlarged cross-sectional view illustrating an appearance after grinding the coated insulating layer 420 shown in FIG. 15, FIG. 17 is a partially enlarged cross-sectional view illustrating a ring electrode 130 formed on the electrically conductive bump 410 shown in FIG. 16, and FIG. 18 is a partially enlarged cross-sectional view illustrating an insulating layer 420 coated on the ring electrode 130 shown in FIG. 17.

The current exemplary embodiment is the same as in the first exemplary embodiment as described with reference to FIGS. 5 and 6, which provides a drum body which is formed of a material having excellent heat conductivity and mechanical strength and has mounting holes on an outer surface of both sides of the cross section of the drum body. Also, identical to the first exemplary embodiment, the current exemplary embodiment bonds a printed circuit board including a control chip, to the mounting holes to externally expose a side face of the printed circuit board. Again, identical to the first exemplary embodiment, the current exemplary embodiment initially bonds the printed circuit body to externally expose a plurality of terminals and process an exposed surface of the drum body and the printed circuit body by lathing.

As shown in FIG. 14, the electrically conductive bump 410 is formed on a terminal 320 connected to a control chip. The conductive bump 410 may be formed to have a thickness greater than 5 μm by electroplating, screen printing using a mask or bumping. The conductive bump 410 may be formed of any one of gold, silver, copper, nickel, tin, lead, and indium, or formed of an alloy thereof. Since the conductive bump 410 is formed on each terminal 320, a plurality of conductive bumps 410 are provided. Identical to the first exemplary embodiment, the conductive bumps 410 may be arranged with a pitch of approximately 40 μm on each sheet of printed circuit board 310.

As shown in FIG. 15, an insulating layer 420 is coated on the exposed surface of the printed circuit board 310 to include the conductive bump 410. The insulating layer 420 may have a thickness of about 1 to 2 μm. As described above, it is possible to initially coat an insulating layer 420 to have a thickness less than a height of a conductive bump 410 and subsequently remove the conductive bump 410 and the insulating layer 420 to have a certain height. Also, it is possible to initially coat an insulating layer 420 on an exposed surface including a conductive bump 410 and subsequently remove a portion of the insulating layer 420 to externally expose the conductive bump 410. This is because a height of the conductive bump 410 is smaller than a thickness of the insulating layer 420.

As shown in FIG. 16, the conductive bump 410 and the insulating layer 420 may be processed by lathing or grinding. During this process, the conductive bump 410 is externally exposed and has an identical height to the insulating layer 420.

As shown in FIG. 17, a plurality of ring electrodes 130 are circumferentially arranged in parallel with a circumferential surface of the drum body and the printed circuit board 310, to pass through the conductive bump 410, through printing.

As shown FIG. 18, an insulating layer 350 is coated on the ring electrode 130. The insulating layer 350 may be formed of parylene.

Furthermore, in the second exemplary embodiment, a connecting part connects each ring electrode 130 and terminal 320, and the subsequently formed insulating layer 420 surrounds the connecting part and the initially formed conductivity bump 410. Since the ring electrode 130 is connected to a control chip by the terminal 320, the control chip may apply a necessary voltage to each ring electrode 130. Even in the second exemplary embodiment, since high a cost laser processing is unnecessary, manufacturing cost may be reduced while productivity is improved.

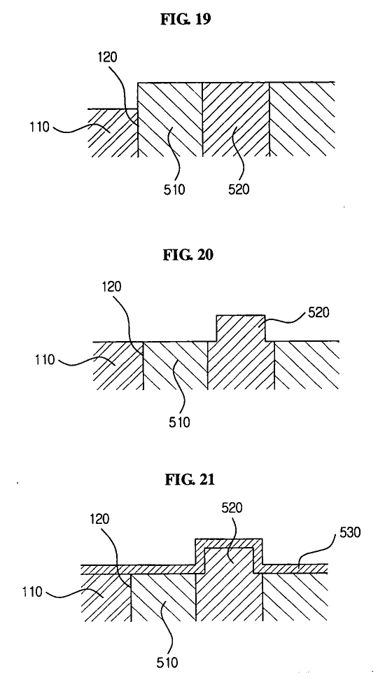

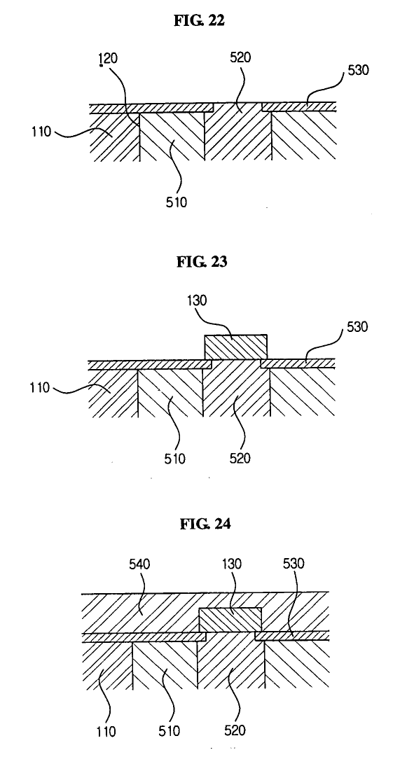

A manufacturing method according to a third exemplary embodiment of the present invention will be described. FIG. 19 is a partially enlarged cross-sectional view illustrating a printed circuit board 510 bonded to a drum body 110, FIG. 20 is a partially enlarged cross-sectional view illustrating a partially etched portion of the printed circuit board 510 shown in FIG. 19, FIG. 21 is a partially enlarged cross-sectional view illustrating an insulating layer 530 coated on an exposed surface of the printed circuit board 510 shown in FIG. 20, FIG. 22 is a partially enlarged cross-sectional view illustrating an appearance after grinding the coated insulating layer 530 shown in FIG. 21, FIG. 23 is a partially enlarged cross-sectional view illustrating a formed ring electrode 130 on the ground exposed surface of the printed circuit board 510 shown in FIG. 22, and FIG. 24 is a partially enlarged cross-sectional view illustrating an insulating layer 530 coated on the ring electrode 130 shown in FIG. 23.

Identical to the first exemplary embodiment, as described with reference to FIG. 5 and FIG. 6, a drum body is provided which is formed of a material having excellent heat conductivity and mechanical strength and has mounting holes on both side surfaces of the cross section of the drum body.

As shown in FIG. 19, a printed circuit board 510 is bonded to the mounting hole 120 of the drum body 110 and is externally protruded from the circumferential surface of the drum body 110, having a certain height. Also, identical to the first exemplary embodiment, a terminal 520 connected with a control chip is externally exposed. In this instance, the control chip is installed in the printed circuit board which is formed by overlapping four sheets of printed circuit boards 510.

As shown in FIG. 20, the printed circuit board 510 is etched by using an etchant so as to externally expose the terminal 520. Namely, the terminal 520 is externally protruded from the printed circuit board 510 by etching portions surrounding the terminal 520.

As shown in FIG. 21, an insulating layer 530 is coated on the exposed surface of the printed circuit board 510 to include the protruded terminal 520. The coating method may utilize various methods such as plating. The insulating layer 530 may be formed of a dielectric material.

As shown in FIG. 22, the protruded terminal 520 and the insulating layer 530 are ground by lathing or polishing. The terminal 520 is externally exposed by the processing as described above.

As shown in FIG. 23, a plurality of ring electrodes 130 are circumferentially arranged in parallel with a circumferential surface of the drum body and the printed circuit board 510 to pass through the exposed terminal 520.

As shown in FIG. 24, an insulating layer 540 is coated on the ring electrode 130. The insulating layer 540 may be formed of parylene.

According to the manufacturing method as described above, the ring electrode 130 is connected to the terminal 520, and the terminal 520 is connected to a control chip (not shown) installed on the printed circuit board 510. Accordingly, the control chip may apply a necessary voltage to each ring electrode 130. Namely, in the present exemplary embodiment, since high cost laser processing is unnecessary, a manufacturing cost may be reduced and productivity may be improved.

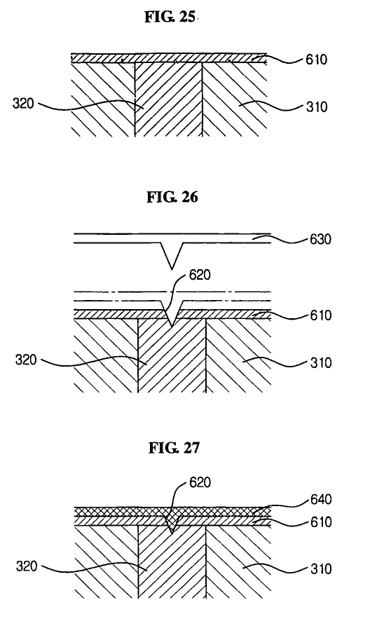

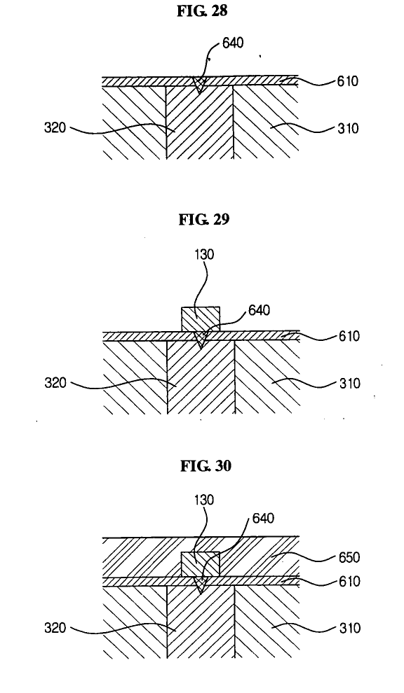

A manufacturing method according to a fourth exemplary embodiment of the present invention will be described. FIG. 25 is a partially enlarged cross-sectional view illustrating an insulating layer 610 coated on a terminal, FIG. 26 is a partially enlarged cross-sectional view illustrating a connection hole 620 formed by piercing the insulating layer 610 shown in FIG. 25 using a piercing tool 630, FIG. 27 is a partially enlarged cross-sectional view illustrating an electrically conductive material 640 filling in the connection hole shown in FIG. 26, FIG. 28 is a partially enlarged cross-sectional view illustrating a remaining portion of the electrically conductive material after processing, FIG. 29 is a partially enlarged cross-sectional view illustrating a formed ring electrode, and FIG. 30 is a partially enlarged cross-sectional view illustrating an insulating layer coated on the ring electrode shown in FIG. 29.

Identical to the first exemplary embodiment, as described with reference to FIG. 5 and FIG. 6, a drum body is provided which is formed of a material having excellent heat conductivity and mechanical strength and has mounting holes on both side surfaces of the cross section of the drum body to face each other in a diameter direction. Also, identical to the first exemplary embodiment, the current exemplary embodiment bonds a printed circuit board including a control chip, to the mounting holes to externally expose a side face of the printed circuit board, after providing the drum body. Likewise, identical to the first exemplary embodiment, the current exemplary embodiment initially bonds the printed circuit body to externally expose a plurality of terminals and processes an exposed surface of the drum body and the printed circuit body by lathing. Details of the fourth exemplary embodiment are described below.

As shown in FIG. 25, an insulating layer 610 is coated on a terminal 320. In this instance, the insulating layer 610 may be formed of parylene and formed to have a thickness of about 3 μm.

As shown in FIG. 26, a connection hole 620 is formed by piercing the insulating layer 610 with a piercing tool 630 to externally expose the terminal 320. As described above, since the terminal 320 is arranged with a pitch of approximately 40 μm, a sharp end of the piercing tool 630 may also be arranged with a pitch of approximately 40 μm. However, this may increase a manufacturing cost because of difficulty in its fabrication. Accordingly, sharp ends of the piercing tool 630 may be arranged with a pitch of approximately 200 μm or approximately 400 μm. In this case, the piercing tool 630 may form each connection hole 620 on each terminal 320 by shifting and piercing.

As shown in FIG. 27, an electrically conductive material 640 is coated on the exposed surface of the printed circuit board 310 including the connection hole 620. The electrically conductive material 640 fills in the connection hole 620.

As shown in FIG. 28, the exposed surface of the printed circuit board formed with the connection hole 620 is ground by lathing or polishing. In this instance, the only electrically conductive material 640 remaining is in the connection hole 620, and the rest is removed from exposed surface of the printed circuit board through processing.

As shown in FIG. 29, a plurality of ring electrodes 130 are circumferentially arranged in parallel with a circumferential surface of the drum body and the printed circuit board 310, to pass through the electrically conductive material 640 filled into the connection hole 620, through printing.

When describing modified exemplary embodiments for forming a ring electrode 130, in addition to the methods described in FIGS. 27 and 28, the electrode ring 130 may be formed on the connection hole 620 in one process at the same time when the electrically conductive material 640 fills in the connection hole 620. Alternatively, in FIG. 28, the ring electrode 130 may be formed by selectively removing the electrically conductive material 640 which remains on the connection hole 620.

As shown in FIG. 30, an insulating layer 650 is coated on the ring electrode 130 and the insulating layer 610.

As described above, in the fourth exemplary embodiment, a connection hole 620 is easily formed by using a piercing tool 630 and utilized as a connecting part connecting each ring electrode 130 and terminal 320. Accordingly, since high cost laser processing is unnecessary, manufacturing cost may be reduced while productivity is improved.

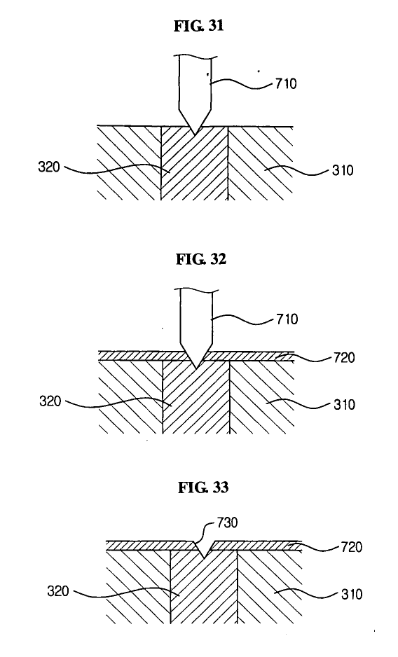

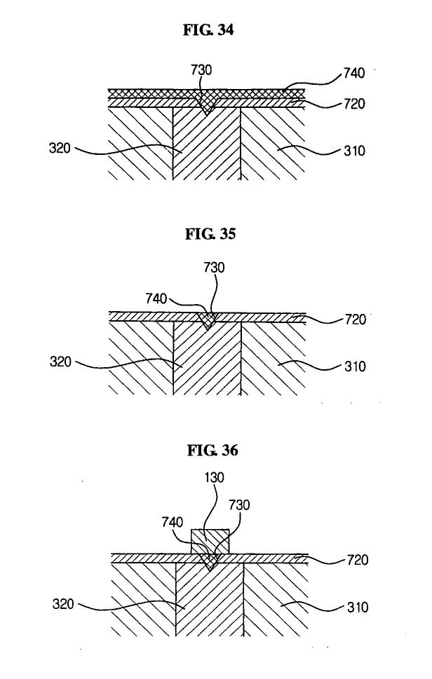

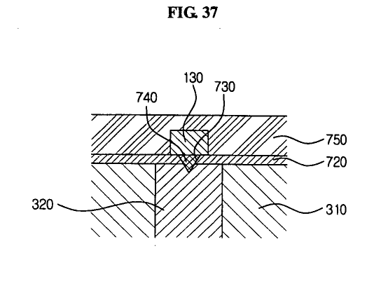

A manufacturing method according to a fifth exemplary embodiment of the present invention will be described. FIG. 31 is a partially enlarged cross-sectional view illustrating a fixing device 710 fixed on a terminal 320, FIG. 32 is a partially enlarged cross-sectional view illustrating an insulating layer formed while the fixing device 710 is fixed on the terminal 320 as shown in FIG. 31, FIG. 33 is a partially enlarged cross-sectional view illustrating a connection hole 730 formed by removing the fixing device 710 shown in FIG. 32, FIG. 34 is a partially enlarged cross-sectional view illustrating a electrically conductive material 740 filled into the connection hole 730 shown in FIG. 33, FIG. 35 is a partially enlarged cross-sectional view illustrating a remaining electrically conductive material 740 filled into the connection hole 730 shown in FIG. 34, after processing, FIG. 36 is a partially enlarged cross-sectional view illustrating a formed ring electrode 130, and FIG. 37 is a partially enlarged cross-sectional view illustrating an insulating layer 750 coated on the ring electrode 130 shown in FIG. 36.

Identical to the first embodiment, as described with reference to FIG. 5 and FIG. 6, a drum body is provided which is formed of a material having excellent heat conductivity and mechanical strength and has mounting holes on both side surfaces of the cross section of the drum body. Also, identical to the first exemplary embodiment, the current exemplary embodiment bonds a printed circuit board including a control chip, to the mounting holes to externally expose a side face of the printed circuit board. Similar to the first exemplary embodiment, the current exemplary embodiment initially bonds the printed circuit body to externally expose a plurality of terminals and processes an exposed surface of the drum body and the printed circuit body by lathing.

As shown in FIG. 31, a fixing device 710 having a sharp end is fixed on a terminal 320. The fixing device 710 may have a sharp end so as to easily fix the terminal 320, and have a certain height.

As shown in FIG. 32, an insulating layer 720 is formed on the terminal 320 while the fixing device 710 is being fixed on the terminal 320. In this instance, the insulating layer 720 does not penetrate into the portion fixed by the fixing device 710. The insulating layer 720 has a thickness of about 3 μm. A height of the fixing device 710 is greater than the thickness of the insulating layer 720.

As shown in FIG. 33, a connection hole 730 is formed by removing the fixing device 710. Namely, since the insulating layer 720 is not formed on a portion of the terminal 320 where the fixing device 710 is fixed, this portion becomes the connection portion 730.

As shown in FIG. 34, the electrically conductive material 740 is coated on the exposed surface of the printed circuit board 310 including the connection portion 730. In this instance, the electrically conductive material 740 fills in the connection hole 730.

As shown in FIG. 35, a surface of the printed circuit board 310 formed with the connection hole 730 is ground by lathing or polishing. Consequently, the electrically conductive material 740 remaining is only in the connection hole 730, and the rest is removed through processing.

As shown in FIG. 36, a plurality of ring electrodes 130 are circumferentially arranged in parallel with a circumferential surface of the drum body and the printed circuit board 310, to pass through the electrically conductive material 740 filled into the connection hole 730, through printing.

When describing modified exemplary embodiments for forming a ring electrode 130, in addition to the methods described in FIGS. 34 and 35, the electrode ring 130 may be formed on the connection hole 730 in one process at the same time when the electrically conductive material 740 fills in the connection hole 730. Alternatively, in FIG. 35, the ring electrode 130 may be formed by selectively removing the electrically conductive material 740 which remains on the connection hole 730.

As shown in FIG. 37, an insulating layer 750 is coated on the ring electrode 130.

As described above, in the fifth exemplary embodiment, a connection hole is formed by initially fixing a fixing device 710 in a portion where the connection hole 730 may be formed and subsequently forming an insulating layer 720 and removing the fixing device 710. The connection hole 730 filled with an electrically conductive material 740 is utilized as a connecting part connecting each ring electrode 130 and terminal 320. Accordingly, since high cost laser processing is unnecessary, a manufacturing cost may be reduced and productivity may be improved.

Therefore, according to the present invention, precision processing using a laser is not needed to form a connecting part which connects each ring electrode and terminal of a control chip. As a result, manufacturing cost may be reduced and also, an image drum may be more widely disseminated.

Also, according to the present invention, an image drum can be readily and easily fabricated, is advantageous for mass production, and can decrease an error rate.

Also, according to the present invention, a manufacturing process is simplified. Accordingly, the manufacturing time and labor may be reduced.

Although exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of manufacturing an image drum for selectively adsorbing a toner thereon so as to form an image, the method comprising:
providing a hollow cylindrical drum body, providing a printed circuit board provided inside of the drum body and exposing a terminal array;
forming a temporary structure to have a predetermined height corresponding to each terminal in the array;
coating an insulating layer on an area excluding the temporary structure;
forming a connection hole by selectively removing the temporary structure;
filling a conductive material in the connection hole; and
forming a plurality of ring electrodes which are circumferentially arranged in parallel with a circumferential surface of the drum body to pass through the conductive material.

2. The method of claim 1, wherein the filling of the conductive material comprises: applying a conductive material over the connection hole, selectively polishing the conductive material and removing the same to leave the conductive material in the connection hole.

3. The method of claim 2, wherein the coating of the insulating layer comprises:
coating the insulating layer on the exposed surface of the printed circuit board including the temporary structure; and
externally exposing the temporary structure by polishing the insulating layer.

4. The method of claim 1, wherein the temporary structure is a fixing device which is fixed on the terminals of the array with a certain height.

5. The method of claim 1, wherein the providing of the printed circuit board further comprises stacking a plurality of sheets of printed circuit boards, Wherein terminals of the array formed on one sheet of printed circuit board and other terminals of the array formed on another sheet of printed circuit board adjacent to the one sheet of printed circuit board are provided to have a certain pitch.

6. The method of claim 1, wherein the providing of the printed circuit board further comprises processing the exposed surface of the drum body and the printed circuit board by lathing after the bonding.

7. The method of claim 1, wherein the forming of the plurality of ring electrodes further comprises coating an insulating layer on the plurality of ring electrodes.

8. The method of claim 1, wherein the providing of the drum body further comprises forming a hollow in the drum body, wherein a mounting hole passes through the hollow to provide the printed circuit board in the hollow.

9. A method of manufacturing an image drum for selectively adsorbing a toner thereon so as to form an image, the method comprising:
providing a hollow cylindrical drum body, providing a printed circuit board inside of the drum body, and exposing a terminal array;
dotting a bead formed of a hydrophobic material on the terminal array;
coating an insulating layer on the exposed surface of the printed circuit board excluding the bead;
forming a connection hole by selectively removing the bead;
filling a conductive material in the connection hole; and
forming a plurality of ring electrodes which are circumferentially arranged in parallel with a circumferential surface of the drum body to pass through the conductive material.

10. The method of claim 9, wherein the coating of the insulating layer comprises:
coating the insulating layer on the exposed surface of the printed circuit board including the bead; and
externally exposing the bead by removing the insulating layer.

11. The method of claim 9, wherein the forming of the connection hole further comprises:
externally exposing the bead by polishing the insulating layer; and
removing the bead by etching the same.

12. The method of claim 9, wherein the filling of the conductive material comprises:
coating the conductive material on the exposed surface of the printed circuit board including the connection hole; and
selectively polishing the conductive material to leave the conductive material in the connection hole.

13. The method of claim 11, wherein the bead is formed of a hydrophobic material.

14. The method of claim 13, wherein the bead is formed of any one of a polydimethylsiloxane, a hydrophobic oil, and a hydrophobic wax, or a combination thereof.

15. The method of claim 13, wherein the coating of the insulating layer comprises:
hardening the dotted bead; and
coating the insulating layer over the bead.

16. The method of claim 9, wherein the forming of the plurality of ring electrodes further comprises coating the insulating layer on the plurality of ring electrodes.

17. The method of claim 16, wherein the insulating layer is formed of parylene.

18. An image drum for selectively adsorbing a toner thereon, so as to form an image, the image drum comprising:
a cylindrical drum body including a mounting hole in a longitudinal direction, and a plurality of ring electrodes which are arranged in parallel with each other on its circumferential surface and electrically insulated from each other;
a printed circuit board, including a control chip for respectively applying voltage to the plurality of ring electrodes, bonded to the mounting hole to externally expose a plurality of terminals making contact with the control chip; and
a connecting part which connects each terminal of the plurality of terminals and each ring electrode of the plurality of ring electrodes respectively by filling an insulating layer in a connection hole, wherein the connection hole is in a sphere shape or in a portion thereof and formed radially on the terminal.

19. The image drum of claim 18, wherein the printed circuit board is formed by stacking a plurality of sheets of printed circuit boards, wherein terminals of the plurality of terminals formed on one sheet of printed circuit board and other terminals of the plurality of terminals formed on another sheet of printed circuit board adjacent to the one sheet of printed circuit board are provided to have a certain pitch.

20. The image drum of claim 18, further comprising an insulating layer coated on the plurality of ring electrodes.

21. The image drum of claim 18, wherein the drum body further comprises a hollow formed in the drum body, wherein the mounting hole passes through the hollow to provide the printed circuit board in the hollow.

22. A method of manufacturing an image drum for selectively adsorbing a toner thereon so as to form an image, the method comprising:
providing a cylindrical drum body including a mounting hole in a longitudinal direction;
bonding a printed circuit board, including a control chip for applying voltage, to the mounting hole to externally expose a plurality of terminals contacting with the control chip;
forming a conductive bump to have a predetermined height on the plurality of terminals;
coating the exposed surface of the printed circuit board excluding the conductive bump, to form an insulating layer; and
forming a plurality of ring electrodes which are circumferentially arranged in parallel with a circumferential surface of the drum body and the printed circuit board to pass through the conductive bump.

23. The method of claim 22, wherein the coating of the exposed surface comprises:
coating the exposed surface of the printed circuit board, including the conductive bump, to form the insulating layer; and
externally exposing the conductive bump by removing a portion of the insulating layer.

24. The method of claim 22, wherein the coating of the exposed surface comprises:
coating the insulating layer to have a thickness less than a height of the conductive bump; and
removing the conductive bump and the insulating layer to have a certain height.

25. The method of claim 22, wherein the conductive bump is formed of any one of gold, silver, copper, nickel, tin, lead, and indium, or formed of an alloy thereof.

26. The method of claim 22, wherein the forming of the plurality of ring electrodes further comprises coating an insulating layer on the plurality ring electrodes.

27. An image drum for selectively adsorbing a toner thereon so as to form an image, the image drum comprising:
a cylindrical drum body including a mounting hole in a longitudinal direction, and a plurality of ring electrodes which are arranged in parallel with each other on its circumferential surface and electrically insulated from each other;
a printed circuit board, including a control chip for respectively applying voltage to the plurality of ring electrodes, bonded to the mounting hole to externally expose a plurality of terminals contacting the control chip; and
a connecting part which connects each ring electrode of the plurality of ring electrodes and conductive bump, which is initially formed on the plurality of terminals, with a subsequently formed insulating layer surrounding the conductive bump.

28. The image drum of claim 27, wherein the printed circuit board is formed by stacking a plurality of sheets of printed circuit boards, wherein terminals of the plurality of terminals formed on one sheet of printed circuit board and other terminals of the plurality of terminals formed on another sheet of printed circuit board adjacent to the one sheet of printed circuit board are provided to have a certain pitch.

29. The image drum of claim 27, wherein an insulating layer is coated on the plurality of ring electrodes.

30. The image drum of claim 27, wherein the drum body further comprises a hollow formed in the drum body, wherein the mounting hole passes through the hollow to provide the printed circuit board in the hollow.

31. A method of manufacturing an image drum for selectively adsorbing a toner thereon so as to form an image, the method comprising:
providing a cylindrical drum body including a mounting hole in a longitudinal direction;
bonding a printed circuit board, including a control chip for applying voltage, to the mounting hole to externally expose a terminal contacting the control chip, wherein the printed circuit board is protruded from a circumferential surface of the image drum;
removing portions of the protruded printed circuit board partially, to allow only a portion of the terminal to protrude;
coating an insulating layer on the exposed surface of the printed circuit board excluding the protruded terminal; and
forming a plurality of ring electrodes which are circumferentially arranged in parallel with a circumferential surface of the drum body and the printed circuit board to pass through the protruded terminal.

32. The method of claim 31, wherein, the removing of the portions of the protruded printed circuit board partially, portions surrounding the terminal are etched by using an etchant.

33. The method of claim 31, wherein the coating of the insulating layer comprises:
coating the insulating layer on the exposed surface of the printed circuit board including the protruded terminal; and
externally exposing the protruded terminal by removing the insulating layer.

34. The method of claim 31, wherein the forming of the plurality of ring electrodes further comprises coating the insulating layer on the plurality of ring electrodes.

35. A method of manufacturing an image drum for selectively adsorbing a toner thereon so as to form an image, the method comprising:
providing a cylindrical drum body including a mounting hole in a longitudinal direction;
bonding a printed circuit board, including a control chip for applying voltage, to the mounting hole to externally expose a terminal contacting the control chip;
coating the externally exposed printed circuit board to form an insulating layer;
forming a connection hole in the insulating layer by piercing the insulating layer with a piercing tool having a sharp end, so as to externally expose the terminal;
filling a conductive material in the connection hole;
forming a plurality of ring electrodes which are circumferentially arranged in parallel with the exposed surface of the drum body and the printed circuit board to pass through the conductive material.

36. The method of claim.35, wherein the filling of the conductive material comprises:
coating the conductive material on the exposed surface of the printed circuit board including the connection hole; and
polishing the conductive material to leave the conductive material in the connection hole.

37. The method of claim 35, wherein the providing of the printed circuit board further comprises stacking a plurality of sheets of printed circuit boards, and a terminal formed on one sheet of printed circuit board and another terminal formed on another sheet of printed circuit board adjacent to the one sheet of printed circuit board are provided to have a certain pitch.

38. The method of claim 37, wherein, in the forming of the connection hole, the connection hole is formed by moving the piercing tool and piercing several times, since both ends of the piercing tool are arranged with a certain pitch and the pitch is larger than the pitch between the terminals.

39. A method of manufacturing an image drum for selectively adsorbing a toner thereon so as to form an image, the method comprising:
providing a cylindrical drum body including a mounting hole in a longitudinal direction;
bonding a printed circuit board, including a control chip for applying voltage, to the mounting hole to externally expose a plurality of terminals contacting the control chip;
fixing a fixing device on the terminal;
coating the exposed surface of the printed circuit board so as to form an insulating layer;
forming a connection hole in the insulating layer where the fixing device is positioned, by separating the fixing device from the terminal;
filling a conductive material in the connection hole; and
forming a plurality of ring electrodes, which are circumferentially arranged in parallel with the exposed surface of the drum body and the printed circuit board, to pass through the conductive material.

40. The method of claim 39, wherein, in the fixing of the fixing device, the fixing device is fixed on the terminal by using its sharpen end.

41. The method of claim 39, wherein the filling of the connection hole comprises:
coating the conductive material on the exposed surface of the printed circuit board; and
leaving the conductive material in the connection hole by polishing the conductive material.

42. An image drum for selectively adsorbing a toner thereon so as to form an image, the image drum comprising:
a cylindrical drum body including a mounting hole in a longitudinal direction;
a plurality of ring electrodes which are arranged in parallel with each other on its circumferential surface and electrically insulated from each other;
a printed circuit board, including a control chip for respectively applying a voltage to ring electrodes, bonded to the mounting hole to externally expose a plurality of terminals contacting the control chip; and
a connecting part which respectively connects each terminal of the plurality of terminals and each ring electrode of the plurality of ring electrodes by filling an insulating layer in the connection hole, wherein the connection hole is in a shape of a pyramid or a cone and formed radially on the terminals.

43. The image drum of claim 42, wherein the connection hole is formed by piercing the insulating layer using a piercing tool with a sharpened end.

44. The image drum of claim 42, wherein the connection hole is formed by initially fixing a fixing device having a sharpened end, providing the insulating layer and removing the fixing device.

45. The image drum of claim 42, wherein the printed circuit board is formed by stacking a plurality of sheets of printed circuit boards, wherein a terminal of the plurality of terminals formed on one sheet of printed circuit board and another terminal of the plurality of terminals formed on another sheet of printed circuit board adjacent to the one sheet of printed circuit board are provided to have a certain pitch.

46. The image drum of claim 42, further comprising an insulating layer coated on the plurality of ring electrodes.

47. The image drum of claim 42, wherein the drum body further comprises a hollow formed in the drum body, wherein the mounting hole passes through the hollow to provide the printed circuit board in the hollow.
